(19) United States
(12) Patent Application Publication
(10) Pub. No.: US 2019/0186670 A1
(43) Pub. Date: Jun. 20, 2019

(54) FINGER-TIGHT HIGH PRESSURE FLUIDIC COUPLING

(71) Applicant: Waters Technologies Corporation, Milford, MA (US)

(72) Inventors: Robert A. JENCKS, Mendon, MA (US); Charles T. MURPHY, Norton, MA (US)

(21) Appl. No.: 16/318,900

(22) PCT Filed: Jul. 21, 2017
(86) PCT No.: PCT/US17/43306

§ 371 Date: Jan. 18, 2019

Related U.S. Application Data
(60) Provisional application No. 62/365,112, filed on Jul. 21, 2016.

(51) Int. Cl. F16L 47/16

(52) U.S. Cl. CPC F16L 47/16

(57) ABSTRACT

Disclosed herein are fluidic couplings for high pressure sealing without tools that can apply large amounts of torque. One embodiment of a fitting includes a compression screw, a fluid-carrying tube extending through a bore in the compression screw, a sleeve disposed around the tube, and a seal coupled to the sleeve such that the seal surrounds a distal end portion of the sleeve. This positioning of the seal can facilitate more efficient sealing using less force and creating less dead volume. Such a fitting can be combined, for example, with a driver having a recess formed therein that can surround the compression screw and transfer rotational force thereto. The driver can include outer surface features, such as knurling, that can facilitate a user directly grasping and tightening the fitting. Further, the fitting can include at least one marking used to achieve a desired seal without overtightening.

### CROSS-REFERENCE TO RELATED APPLICATIONS

This application claims the benefit of U.S. Provisional Application No. 62/365,112, filed Jul. 21, 2016, entitled “Finger-tight High Pressure Fluidic Coupling.” This application is incorporated by reference in its entirety.

### FIELD

This disclosure relates generally to fluidic couplings and, more particularly, to high pressure fluidic couplings that can be achieved with finger-tightening of components.

### BACKGROUND

There are many applications that require fluid delivery at elevated pressures. For example, chemical analysis systems often include fluid channels that accommodate high pressures. A liquid chromatography system, such as a system designed for high- or ultra-performance liquid chromatography (HPLC/UPLC), can operate at pressures at or above thousands of pounds per square inch. The fluid channels in such systems, along with fluidic couplings that join the channels to one another and/or to other system components, must be capable of withstanding such pressures and delivering on required performance metrics.

In low flow fluid delivery applications, such as nanoscale liquid chromatography, fused silica can be utilized to form capillary tubing. Fused silica tubing can be desirable due to its smooth bore finish, precise bore diameter, ability to withstand system operating pressures, and the chemically inert nature of the material. Fused silica can be fragile, however, and establishing high pressure fluidic couplings can be difficult. For example, fused silica tubing often includes a reinforcing polyimide coating that can have a low coefficient of friction. When used in connection with a polymer sleeve and ferrule or an adapter ferrule type fluidic coupling, the low friction outer surface of the tubing can slip, resulting in a failed connection and a high pressure ejection of the tubing from the fitting.

A conventional method for addressing this problem is a stainless steel tube radially crimped onto a fused silica tube using a polymer sleeve in between as a seal. This sleeve and tube assembly can be fastened into a port or receptacle using a conventional stainless steel ferrule or other annular sealing element and a compression screw. More particularly, to form a fluid-tight coupling a tube having the ferrule or annular sealing element displaced away from the end face thereof can be inserted into the receptacle or port of a coupling body. The receptacle can be defined by a cylindrical bore that transitions to a conical bore which transitions to a smaller diameter cylindrical bore. A fluid channel can extend from the surface at the bottom of the smaller diameter cylindrical bore into the coupling body. The cone angle of the conical bore can be greater than the cone angle of the annular sealing element, resulting in a seal along the circumferential contact between the annular sealing element and the surface of the conical bore as the sealing element is urged into the port by a compression screw threaded into the larger cylindrical bore. This circumferential contact seal is formed along the side of the sleeve and tube assembly. Additional force applied by a compression screw after achieving initial contact between the annular sealing element and the conical bore surface can result in a contact seal between the annular sealing element and the outer surface of the sleeve.

While the above-described configuration can improve the pressure capability and robustness of the connection, there are still disadvantages. For example, tightening this type of fitting requires both user's hands to simultaneously hold the tube securely into the bottom of the port while tightening the compression screw with a wrench. If the end face of the tubing is not in contact with the bottom of the cylindrical bore as the fitting is tightened, the region between the outer surface of the tubing and the side wall of the smaller cylindrical bore below the circumferential contact seal can represent unswept or dead volume. During a chromatographic measurement, for example, analytes can become trapped in the unswept volume and gradually diffuse into the fluid flow, thereby degrading the chromatographic measurement data. Moreover, corrosion may occur at the capillary interface, leading to further degradation of chromatographic measurements.

Further, the fused silica tubing can fracture if a user overtightens the connection due to excessive axial force pressing the tubing into the bottom of the port. Fractured fused silica tubing can cause downstream complications in the system, as pieces of the tubing can be carried through the system and can damage sensitive components, such as a chromatography column.

Additionally, chromatography and other fluid delivery systems utilizing conventional fittings require ports having a conical bore, as described above. Forming a conical bore can be more expensive and time-intensive than forming a simple cylindrical bore, and polishing operations can be required to ensure the conical bore provides a good sealing surface for a ferrule or other annular sealing element.

Still further, conventional stainless steel ferrule compression fittings rely on permanently deforming the ferrule and tube to create a seal. This deformation essentially freezes the ferrule in a position along the tube where the length of tube extending from the ferrule matches the dimensions of the port in which it was initially installed. Due to port manufacturing tolerance variations, using the fitting in any other port poses a risk of increased unswept volume (if the distance between the tip of the ferrule and the bottom of the port is longer) or tubing fracture (if the distance between the tip of the ferrule and bottom of the port is shorter). And even if used in the same port, the number of times a ferrule can be reused is limited because of the permanent deformation that occurs each time the fitting is tightened.

Accordingly, there is a need for improved high pressure fluidic couplings that address the above-described and other drawbacks of conventional couplings.

### SUMMARY

The present disclosure generally provides finger-tight high pressure fluidic couplings that address a number of drawbacks of conventional fluidic couplings. The fluidic couplings described herein generally include a seal that surrounds a distal end of a fitting so as to create a fluid seal between two fluidic paths at a distal end of the fitting, rather than at a location proximal thereto. In some embodiments, for example, a polymer tip can be included on a fitting that can create a high pressure fluid seal at the bottom of a fluidic port into which the fitting is threaded. By forming a seal at the tip of the fitting, a ferrule or other annular sealing element can be eliminated and the amount of force necessary to create a seal can be reduced. This can allow the fitting to be finger-tightened by a user without the need for a wrench or other tool.

The fittings described herein can provide a number of advantages over conventional compression fittings. For example, elimination of the need for tools to install the fittings, elimination of the need for two hands to separately hold the fluid-carrying tubing and the compression screw or tool coupled thereto, and elimination of the need for a conical bore can simplify manufacturing and use of the systems employing the fittings. Further, by forming the fluid seal at the bottom of a port, the amount of unswept volume can be minimized. Still further, the presence of a seal at the distal end of the fitting can protect the fluid carrying tubing from excessive axial forces, which can prevent fracture of the tubing during tightening.

The fittings described herein can provide a number of other advantages as well, including the ability to selectively separate the seal from the remainder of the fitting. This can allow for replacement of a seal if it becomes degraded due to damage or overuse. Furthermore, the fittings described herein can include features to aid a user in properly finger-tightening the compression screw. Such features can include, for example, a visual tightening aid in the form of a marking on a part of the fitting. The visual tightening aid can be utilized to indicate to a user a range of angular displacement that is sufficient to create a fluid seal without damaging components of the fitting. Still further, use of the fittings described herein can allow for the use of simpler cylindrical receptacles or ports that do not include a conical bore portion. These simplified ports can be created using fewer manufacturing operations and need not be subjected to complicated polishing, lapping, or other processing.

In one aspect, a fitting for coupling fluidic paths is provided that includes a compression screw having threads formed along at least a portion of an outer surface thereof and a drive surface formed at a distal end thereof. The fitting further includes a tube extending through an axial bore of the compression screw that is configured to carry fluid, and a sleeve disposed around the tube that includes a drive feature formed on an outer surface thereof that is configured to abut against the drive surface of the compression screw. The fitting also includes a seal coupled to the sleeve such that the seal surrounds a distal end portion of the sleeve. The seal includes an axial bore formed between a distal sealing face and a proximal sealing face of the seal that is aligned with a fluid path of the tube.

The devices and methods described herein can have a number of additional features and/or variations, all of which are within the scope of the present disclosure. In some embodiments, for example, a distal end of the tube and a distal end of the sleeve can be positioned proximal to the proximal sealing face of the seal. In other embodiments, the seal can include a recess formed in the proximal sealing face thereof that is coaxial with the axial bore formed through the seal. This recess can have a diameter substantially equal to a diameter of the tube. Providing this recess can allow, in some embodiments, the tube to extend into the recess as pressure is applied to the fitting by the compression screw.

In other embodiments, the seal can include an annular ridge formed on the distal sealing face that surrounds the axial bore. The annular ridge can aid in creating a seal between the distal sealing face of the seal and a sealing surface of a coupling port into which the fitting is threaded or otherwise inserted.

The seal can have a variety of configurations but, in some embodiments, the seal can have a generally cylindrical shape with the proximal sealing face being recessed below a proximal end of a sidewall of the seal such that the sidewall of the seal is disposed around the distal end portion of the sleeve when a distal end of the sleeve abuts against the proximal sealing surface of the seal. Further, the sidewall of the seal can include one or more features formed on an inner surface thereof that can be configured to interface with one or more complementary features formed on an outer surface of the sleeve to prevent the seal from separating from the sleeve. Examples of such features can include, for example, a radially inward extending protrusion. In such an embodiment, the one or more complementary features formed on the outer surface of the sleeve can include a groove or other depression into which the protrusion can fit to prevent separation of the seal from the sleeve. The complementary features on the seal and/or sleeve can be configured to prevent relative rotation therebetween in some embodiments, and permit relative rotation therebetween in other embodiments (e.g., via a continuous groove around a circumference of the sleeve).

In certain embodiments, the seal can be configured for selective separation from the distal end portion of the sleeve to allow, for example, for replacement thereof. For example, in some embodiments the sidewall of the seal can include at least one slot formed therein that extends along a portion of a length of the seal to allow for temporary deformation of the seal as it passes into position over a distal end of the sleeve. In other embodiments, an outer distal edge of the sleeve can be chamfered to facilitate insertion of the distal end portion of the sleeve into a recess of the seal.

The seal can be formed from a variety of different materials and can have a variety of sizes. In some embodiments, for example, the seal can be formed from a polymer. Other components of the fittings can be formed from a variety of materials as well. For example, the tube can be formed from stainless steel in some embodiments, while in other embodiments the tube can be formed from fused silica. In embodiments that utilize stainless steel, the tube can be welded or otherwise coupled to the sleeve directly. In embodiments that utilize fused silica, however, the fitting can further include a second sleeve that is disposed between the tube and the sleeve. This second sleeve can be formed from a variety of materials but, in some embodiments, can be formed from polyether ether ketone (PEEK). The second sleeve can serve to protect the more fragile fused silica and, in some embodiments, can provide a more robust structure for coupling the sleeve to the tube via, for example, crimping.

In some embodiments, the fitting can further include a housing having a coupling port formed therein that can include a first bore having threads formed along at least a portion of a length thereof, a second bore of smaller diameter than the first bore, and a fluid passage of smaller diameter than the second bore. The compression screw can be configured to threadably mate with the first bore and the sleeve and the seal can be configured to extend into the second bore such that the tube and the axial bore formed in the seal align with the fluid passage. The coupling port can, in some embodiments, have a structure that is easier to manufacture than conventional coupling ports due to a simpler architecture (e.g., no need for a conical transition section, etc.). For example, in some embodiments an angle between a bottom surface of the first bore and a sidewall of the first bore can be about 90° and an angle between a bottom surface of the second bore and a sidewall of the second bore can be about 90°.

The compression screw can, in some embodiments, include a proximal portion having at least one feature formed thereon that is configured to facilitate rotation of the compression screw. Such a feature can include a recession, protrusion, pattern, or other feature to facilitate a user grasping the compression screw. In addition, the at least one feature can be configured to interface with a driver that a user can grasp to impart rotational force to the compression screw. For example, in some embodiments the fitting can include a driver configured to selectively mate with the proximal portion of the compression screw such that rotation of the driver is transferred to the compression screw. The driver can include, for example, a recess formed therein that is configured to receive the proximal portion of the compression screw therewithin. In some embodiments, an outer surface of the driver can be configured to be grasped directly by the user to rotate the compression screw, thereby providing a fitting capable of finger-tightening. Moreover, the driver can include at least a visual tightening aid for creating a seal between the tube and the fluid passage of the housing. The visual tightening aid can, in some embodiments, include a wedge-shaped region formed on a proximal surface of the driver. A leading edge of the region can correspond to a minimum tightening displacement and a trailing edge of the region can correspond to a maximum tightening displacement.

In another aspect, a driver is provided that includes an elongate body and at least one feature formed on an outer surface of the elongate body that is configured to facilitate a user gripping the elongate body. The driver further includes a recess formed in a distal end of the elongate body that is configured to surround a proximal end of a fitting compression screw, and a slot formed along an axial length of the elongate body that extends from an outer surface of the elongate body to at least halfway through a width of the elongate body, where the slot is configured to receive a tube extending from a proximal end of the fitting compression screw. Further, at least one wall of the recess includes at least one feature formed thereon that is configured to interface with at least one feature formed on the fitting compression screw such that rotation of the elongate body is transferred to the fitting compression screw.

As with the instrument described above, a number of variations and additional features are possible. For example, in some embodiments the at least one feature formed on the at least one wall of the recess can include a plurality of splines. Further, the at least one feature formed on an outer surface of the elongate body can include knurling. In other embodiments, however, other features can be included on either the walls of the recess or the outer surface of the driver, including any combination of recesses and protrusions of various geometries, pattern textures, or other features that facilitate user grasping in the case of the outer surface, or rotational force transmission to the compression screw in the case of the recess wall or walls.

The driver can be formed from a variety of materials and, in some embodiments, can be formed from a polymer. Further, the slot in some embodiments can extend through a center of the elongate body so as to accommodate a tube extending from the compression screw that is also coaxially aligned with the compression screw. In still other embodiments, as noted above, a proximal end portion of the driver can include a visual tightening aid for properly torqueing the fitting compression screw. The visual tightening aid can, in some embodiments, include a wedge-shaped region formed on a proximal surface of the driver. A leading edge of the region can correspond to a minimum tightening displacement and a trailing edge of the region can correspond to a maximum tightening displacement.

In another aspect, a method for coupling fluidic paths is provided that includes threading a compression screw of a fitting into a port until a seal surrounding a distal end portion of the fitting contacts a bottom surface of the port. The method further includes coupling a driver to the compression screw by sliding the driver distally onto a proximal end of the compression screw such that the proximal end of the compression screw is received within a recess formed in a distal end of the driver and complementary mating features formed on the driver and the compression screw interface to prevent relative rotation between the driver and the compression screw. The method also includes rotating the driver from a first position to a second position, wherein an angle between the first position and the second position corresponds to an angle indicated by a visual tightening aid formed on the driver.

As with the above-described devices, there are a number of variations and additional steps that can be included in the methods disclosed herein. For example, in some embodiments rotating can be accomplished by a user directly grasping the driver. In other embodiments, the method can further include aligning the driver and the compression screw in a coaxial orientation by passing a tube extending from a proximal end of the compression screw through a slot formed along a length of the driver and extending from a center of the driver to an outer surface thereof.

In still other embodiments, the method can further include orienting the driver relative to the compression screw prior to coupling the driver to the compression screw such that a position of a reference feature on the driver relative to the compression screw is known. In certain embodiments, the method can further include separating the driver from the compression screw by sliding the driver proximally until the proximal end of the compression screw is free of the recess formed in the distal end of the driver, as well as rotating the driver to change its orientation relative to the compression screw, and repeating the coupling step.

In another aspect, a fitting for coupling fluidic paths is provided that includes a housing having a coupling port formed therein, wherein the coupling port includes a first bore having threads formed along at least a portion of a length thereof, a second bore of smaller diameter than the first bore, and a fluid passage of smaller diameter than the second bore. The fitting further includes a tube configured to extend through the first bore and the second bore, where the tube is configured to carry fluid. The fitting also includes a sleeve disposed around the tube and configured to extend through the first bore and the second bore, where the sleeve further includes a drive feature formed on an outer surface thereof. The fitting also includes a compression screw having threads formed along at least a portion of an outer surface thereof that are configured to interface with the threads of the first bore, and the compression screw is disposed around the tube such that a distal facing drive surface of the compression screw abuts against the drive feature of the sleeve. The fitting further includes a seal coupled to the sleeve such that the seal surrounds a distal end portion of the sleeve and an axial bore formed through the seal aligns with a fluid path of the tube. Moreover, an angle between a bottom surface of the first bore and a sidewall of the first bore is about 90° and an angle between a bottom surface of the second bore and a sidewall of the second bore is about 90°.

Any of the variations and additional features described above, along with others, can be included in the above-described fitting. For example, in some embodiments a distal end of the tube and a distal end of the sleeve can be positioned proximal to a proximal sealing face of the seal. In other embodiments, the seal can further include a recess formed in the proximal sealing face thereof that is coaxial with the axial bore formed through the seal. The recess, in some embodiments, can have a diameter substantially equal to a diameter of the tube.

In certain embodiments, the seal can further include an annular ridge formed on a distal sealing face that surrounds the axial bore. The seal itself can have a generally cylindrical shape with a proximal sealing face being recessed below a proximal end of a sidewall of the seal such that the sidewall of the seal can be disposed around the distal end portion of the sleeve when a distal end of the sleeve abuts against the proximal sealing surface of the seal. The sidewall of the seal can include one or more features formed on an inner surface thereof that can be configured to interface with one or more complementary features formed on an outer surface of the sleeve to prevent the seal from separating from the sleeve. For example, the one or more features formed on the inner surface of the sidewall of the sleeve can include a radially inward extending protrusion and the one or more complementary features formed on the outer surface of the sleeve can include a groove.

In some embodiments, the sidewall of the seal can include at least one slot formed therein that extends along a portion of a length of the seal. In these and other embodiments, the seal can be configured for selective separation from the distal end portion of the sleeve and an outer distal edge of the sleeve can be chamfered to facilitate insertion of the distal end portion of the sleeve into a recess of the seal.

As noted above, the various components of the fitting can be formed from a variety of materials. For example, in some embodiments the seal can be formed from a polymer. In other embodiments, the tube can be formed from stainless steel. In still other embodiments, the tube can be formed from fused silica. In such embodiments, the fitting can also include a second sleeve that is disposed between the tube and the sleeve. This second sleeve can serve to reinforce and protect the tube and, in some embodiments, can be formed from polyether ether ketone (PEEK).

The compression screw can, in some embodiments, include a proximal portion having at least one feature formed thereon that is configured to facilitate rotation of the compression screw. In some embodiments, the fitting can further include a driver configured to selectively mate with the proximal portion of the compression screw such that rotation of the driver is transferred to the compression screw. The driver, in some embodiments, can include a recess formed therein that can be configured to receive the proximal portion of the compression screw therewithin. An outer surface of the driver in some embodiments can be configured to be grasped directly by a user to rotate the compression screw. And, in some embodiments, the driver can include a visual tightening aid for creating a seal between the tube and the fluid passage of the housing. The visual tightening aid can, in some embodiments, include a wedge-shaped region formed on a proximal surface of the driver. A leading edge of the region can correspond to a minimum tightening displacement and a trailing edge of the region can correspond to a maximum tightening displacement.

Any of the features or variations described above can be applied to any particular aspect or embodiment of the disclosure in a number of different combinations. The absence of explicit recitation of any particular combination is due solely to the avoidance of repetition in this summary.

### BRIEF DESCRIPTION OF THE DRAWINGS

FIG. 1 is a perspective view of a prior art fluidic coupling for a rotary shear seal valve in a liquid chromatography system;

FIG. 2 is a cross-sectional view of a prior art compression fitting for coupling fluidic paths;

FIG. 3 is a perspective view of one embodiment of an assembly including fittings according to the teachings provided herein;

FIG. 4 is an exploded view of a fitting assembly of FIG. 3;

FIG. 5 is a cross-sectional view of the fitting assembly of FIG. 3 threaded into one embodiment of a coupling port;

FIG. 6 is a detail view of a distal portion of FIG. 5;

FIG. 7 is a cross-sectional view of the fitting assembly of FIG. 4;

FIG. 8 is a detail view of a distal portion of the fitting assembly of FIG. 7;

FIG. 9 is a partial front perspective view of the fitting assembly of FIG. 4;

FIG. 10 is a partial rear perspective view of the fitting assembly of FIG. 9;

FIG. 11 is a front perspective view of the seal of FIG. 4;

FIG. 12 is a rear perspective view of the seal of FIG. 11;

FIG. 13 is a front perspective view of the compression screw of FIG. 4;

FIG. 14 is a rear perspective view of the compression screw of FIG. 13;

FIG. 15 is a bottom perspective view of the driver of FIG. 4;

FIG. 16 is a top view of the driver of FIG. 15;

FIG. 17 is an exploded view of another embodiment of a fitting assembly for coupling fluidic paths according to the teachings provided herein;

FIG. 18 is a top view of the driver of FIG. 17;

FIG. 19 is a cross-sectional view of the fitting assembly of FIG. 17;

FIG. 20 is a detail view of a distal portion of the fitting assembly of FIG. 19;

FIG. 21 is a top view of one embodiment of a driver including a visual tightening aid;

FIG. 22 is a top view of the driver of FIG. 21 in a first position;

FIG. 23 is a top view of the driver of FIG. 21 in a second position aligned to a reference position;

FIG. 24 is a top view of the driver of FIG. 21 in a third position at a minimum tightening displacement;

FIG. 25 is a top view of the driver of FIG. 21 in a fourth position at a maximum tightening displacement; and

FIG. 26 is a cross-sectional view of one embodiment of a fitting for coupling fluidic paths according to the teachings provided herein.

### DETAILED DESCRIPTION

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present disclosure is defined solely by the claims. The features illustrated or described in connection with one exemplary embodiment may be combined with the features of other embodiments. Such modifications and variations are intended to be included within the scope of the present application. To the extent features are described herein as being a “first feature” or a “second feature,” such numerical ordering is generally arbitrary, and thus such numbering can be interchangeable. Further, in the present disclosure, like-numbered components of the various embodiments generally have similar features when those components are of a similar nature and/or serve a similar purpose.

Additionally, the figures are not necessarily to scale and, to the extent that linear or circular dimensions are used in the description of the disclosed instruments and methods, such dimensions are not intended to limit the types of shapes that can be used in conjunction with such instruments and methods. A person skilled in the art will recognize that an equivalent to such linear and circular dimensions can easily be determined for any geometric shape. Still further, sizes and shapes of the devices, and the components thereof, can depend at least on the size and shape of components with which the devices will be used, and the methods and procedures in which the devices will be used.

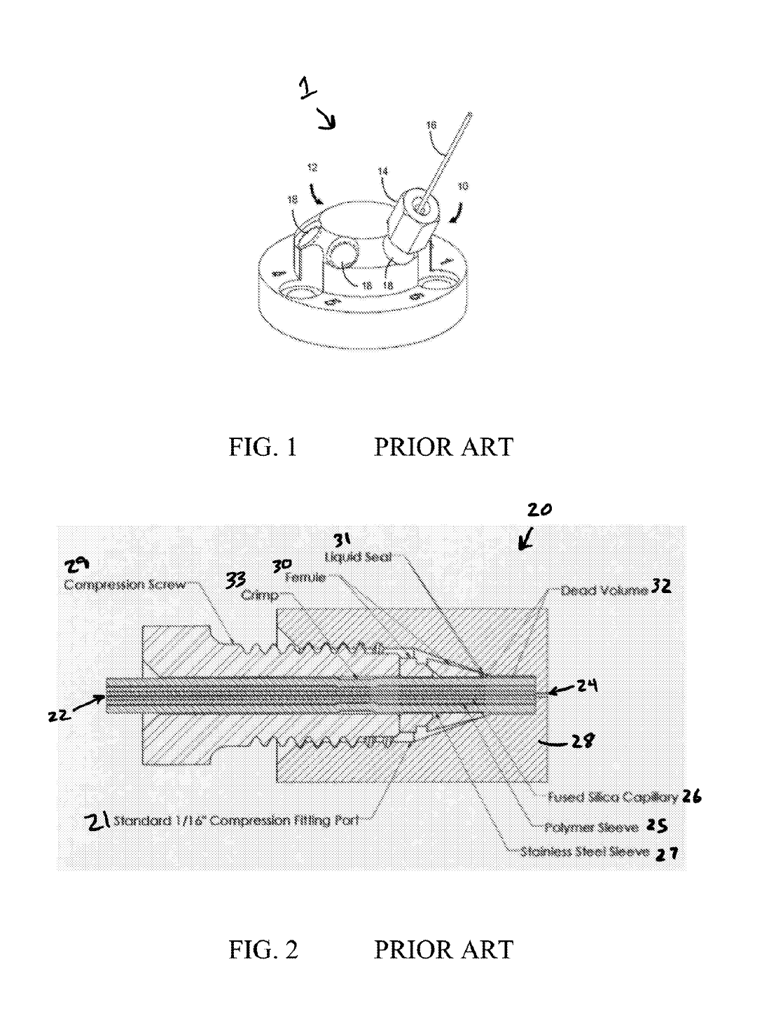

FIG. 1 illustrates a capillary fluidic coupling 10 at a stator portion 12 of a rotary shear seal valve 1 for a liquid chromatography system. The fluidic coupling 10 includes a compression nut 14 and additional components (not shown). A tube 16 defines a fluid channel that conducts a fluid from a chromatographic system component to one of the stator ports 18 or from the stator port to another chromatographic system component. By way of example, the chromatographic system component can be an injection valve or a chromatography column. A second fluid channel is defined inside the stator portion 12 and interfaces with a rotor portion of the rotary shear seal valve 1 to couple, or decouple, the second fluid channel with a third fluid channel in communication with one of the other stator ports 18. The fluidic coupling 10 must be capable of withstanding high pressures, e.g., on the order of thousands of pounds per square inch in some chromatographic systems.

FIG. 2 shows a cross-sectional view of a conventional fitting 20 that can be used, for example, to couple two fluid channels 22 and 24. For example, the fitting 20 can be used to couple the tube 16 of FIG. 1 to an internal fluid channel in the rotary shear seal valve 1. The fitting 20 can include a port 21 formed in a coupling body 28 that can receive a tube 26 that includes the first fluid channel 22 to be coupled to the second fluid channel 24 inside the coupling body 28. The tube 26 can, in some embodiments, be a metal tube, such as a stainless steel tube. In other embodiments, however, the tube 26 can be formed from other materials, including fused silica. In embodiments that make use of a fused silica tube 26, a polymer sleeve 25 can be formed therearound. The polymer sleeve 25 can be formed from, for example, polyether ether ketone (PEEK) in some embodiments. Moreover, a metal sleeve 27, such as a stainless steel sleeve, can be coupled to the polymer sleeve 25 using, e.g., a crimp connection 33, such as one or more crimps disposed around a circumference of the sleeve. A ferrule 30 that is compressed by a compression screw 29 can engage an inner conical surface of the coupling body 28 and the outer surface of the metal sleeve 27. The resulting fluidic seal 31 can withstand a high fluid pressure (e.g., greater than about 10,000 psi or greater than about 15,000 psi); however, an unswept or “dead” volume 32 can be formed in the unoccupied region of the bore that surrounds the sleeve 27 and is to the right of the liquid seal 31 in the figure (i.e., where the ferrule part 30 is in contact with the conical surface of coupler body 28). The presence of the unswept volume 32 can result in sample carryover. For example, as the sample moves from the first fluid channel 22 into the second fluid channel 24, some of the sample can diffuse into the unswept volume 32. Subsequently, the sample present in the unswept volume 32 can diffuse back into the main fluid flow and into the second fluid channel 24. If the fitting 20 is used with components of a liquid chromatography system, such as illustrated in FIG. 1, the fluid sample that diffuses back into the fluid flow (i.e., the carryover) can adversely affect chromatographic measurements.

As noted above, conventional fittings like the one shown in FIGS. 1 and 2 have a number of additional drawbacks as well. For example, tightening the fitting 20 can require both user's hands to simultaneously hold the tube 26 (or tube assembly that includes the tube 26, polymer sleeve 25, and metal sleeve 27) securely into the bottom of the port while tightening the compression screw with a wrench to create the fluid seal 31. Further, the fused silica tube 26 can fracture if a user overtightens the connection due to excessive axial force pressing the tube 26 into the bottom of the port. Fractured fused silica tubing can cause downstream complications in the system, as pieces of the tubing can be carried through the system and can damage sensitive components, such as a chromatography column.

Additionally, chromatography and other fluid delivery systems utilizing conventional fittings like the fitting 20 require ports having a conical bore to interface with the ferrule 30. Forming a conical bore can be more expensive and time-intensive than forming a simple cylindrical bore, and more complicated polishing operations can be required to ensure the conical bore provides a good sealing surface for a ferrule or other annular sealing element. Still further, conventional stainless steel ferrule compression fittings rely on permanently deforming the ferrule 30 and metal sleeve 27 to create a seal. This deformation essentially freezes the ferrule 30 in a position along the sleeve 27 where the length of tube 26 extending from the ferrule matches the dimensions of the port in which it was initially installed. Due to port manufacturing tolerance variations, using the fitting in any other port can pose a risk of increased unswept volume (if the distance between the tip of the ferrule 30 and the bottom of the port 21 is longer) or tubing fracture (if the distance between the tip of the ferrule 30 and bottom of the port 21 is shorter). And even if used in the same port, the number of times a ferrule can be reused is limited because of the permanent deformation that occurs each time the fitting is tightened.

The present disclosure provides alternative fluidic couplings that can withstand high pressures (e.g., pressures at or above thousands of pounds per square inch) while minimizing unswept volume, reducing the amount of torque required to create the fluid seal—thereby enabling a user to finger tighten a fitting—and simplifying manufacturing processes. Moreover, the fluidic couplings described herein protect against tube fracture due to overtightening, can be reused in different ports without risk of undesirable performance, and have a replaceable seal component that allows for extended operation life via individual component replacement.

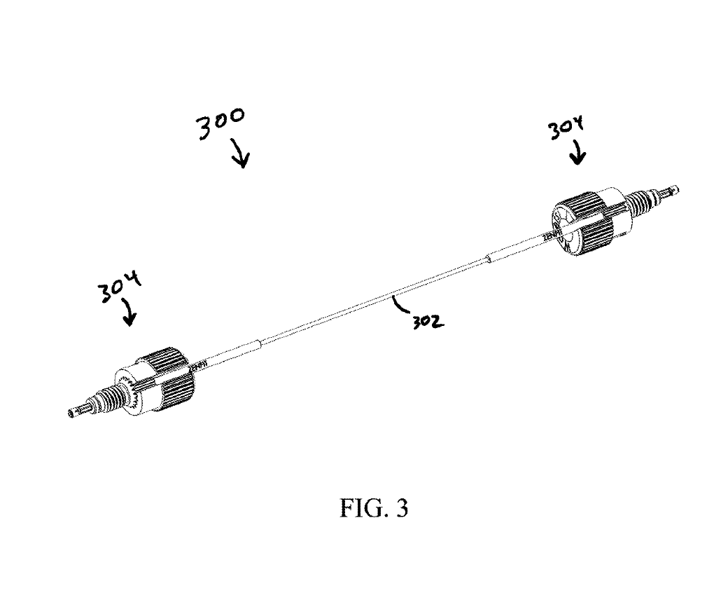

FIG. 3 illustrates a perspective view of one embodiment of a fluidic coupling assembly 300 according to the teachings of the present disclosure. The coupling assembly 300 is illustrated as a length of tubing 302 that has a male fitting assembly 304 at each end thereof. Each fitting assembly 304 can be threaded into a port formed in a coupling body to make a fluid-tight high pressure coupling between, e.g., two components in a chromatography or other system.

The tubing 302 can be formed from a variety of materials depending upon the size and length of the tubing, as well as the pressure it must carry, its flexibility, its chemical characteristics (e.g., imperviousness to various solvents used in a chromatography system), etc. In some embodiments, the tubing 302 can be stainless steel. In other embodiments, however, the tubing 302 can be formed from fused silica. Fused silica is commonly used in low flow fluid delivery applications, such as nanoscale liquid chromatography. Fused silica tubing can be desirable due to its smooth bore finish, precise bore diameter, ability to withstand system operating pressures, and the chemically inert nature of the material.

Each of the fitting assemblies 304 coupled to the tubing 302 can be configured to be threaded into a port formed in a coupling body, such as the stator port 18 of the rotary shear seal valve 1 described above. The fittings 304 and tubing 302 can be produced in a number of different sizes, according to desired application. In nanoscale liquid chromatography, for example, coupling ports are often found in standard 1/16-inch and 1/32-inch fluid passage diameters.

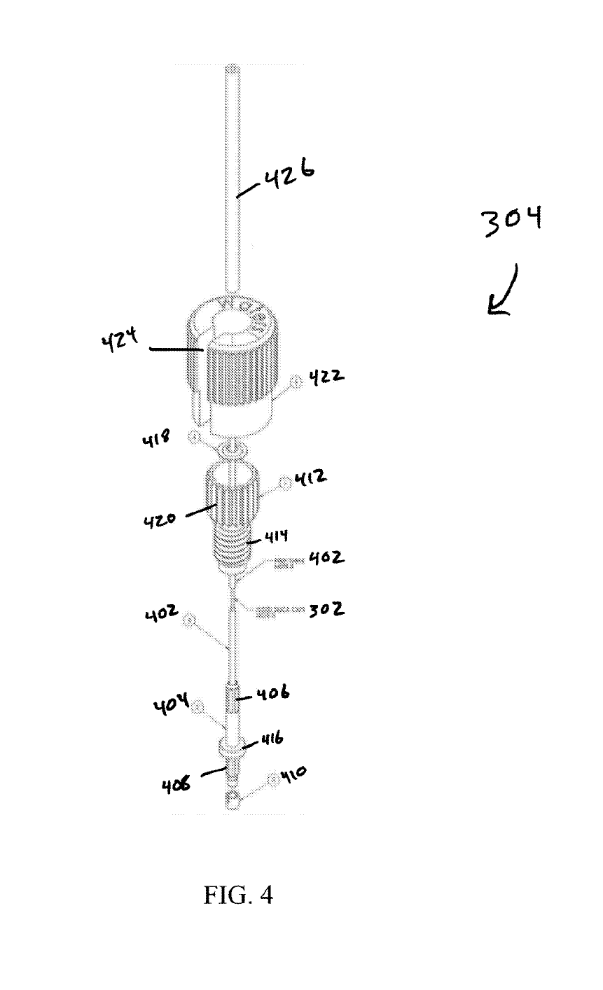

Each fitting assembly 304 can include a number of components, as shown in FIG. 4. In the illustrated embodiment, the inner-most component can be the length of fused silica tubing 302. Because the fused silica tubing 302 can be fragile, it can be surrounded by a polymer sleeve 402. The polymer sleeve 402 can be polyether ether ketone (PEEK) in some embodiments. Coupled to the polymer sleeve 402 can be a further sleeve 404. The sleeve 404 can be formed from a metal in some embodiments, such as stainless steel. The sleeve 404 can be coupled to the polymer sleeve 402 and tubing 302 using a crimp connection in some embodiments. For example, in FIG. 4 a proximal first crimp 406 and a distal second crimp 408 are shown. Both of the first and second crimps 406, 408 can be, for example, a series of crimps extending around the circumference of the sleeve 404 to securely couple the sleeve 404 to the polymer sleeve 402 and tubing 302. The crimps 406, 408 can also serve to create a fluid-tight seal that prevents fluid from traveling between the metal sleeve 404 and the polymer sleeve 402.

A seal 410 can be disposed around a distal end of the sleeve 404 to aid in forming a fluid-tight coupling when the fitting assembly 304 is threaded into a coupling port. The seal 410 can be formed from a material that is compliant enough to form a seal against the bottom of a coupling port but strong enough to withstand the high fluid pressures utilized in, e.g., liquid chromatography systems. Accordingly, the seal can be formed from a high strength polymer material in some embodiments. It can also be desirable that the seal be inert and impervious to the various solvents and other compounds being passed through the tubing 302. In one embodiment, the high strength polymer material can be formed from a polyimide. In other embodiments, however, other materials known in the art that are suitable for forming a fluid seal can be employed.

Moving toward a proximal end of the fitting 304, a compression screw 412 can be included to provide distal axial force to create a fluid-tight seal at the distal end of the fitting. The compression screw 412 can include threads 414 formed along at least a portion of an outer surface thereof that can interface with threads formed on an inner sidewall of a coupling port in order to urge the compression screw proximally or distally within the port. A distal end of the compression screw 412 can include a drive surface (not visible in the figure) that abuts against a drive feature 416 formed on the sleeve 404, such as a protrusion like a shoulder, etc., in order to urge the sleeve 404 distally when inserted into a coupling port. The assembly 304 can also include a retainer 418 that can couple to a proximal end of the sleeve 404 and prevent the compression screw 412 from moving proximally away from the sleeve 404. The combination of the drive feature 416, retainer 418 can permanently couple the compression screw 412 to the remainder of the fitting assembly 304 (though the screw can be rotated relative to other components, such as the sleeve 404 and tubing 302). This can eliminate the need for a user to hold tubing in place with one hand as they thread in a compression screw with the other, as is common with the above-described conventional ferrule-type fittings.

A proximal end of the compression screw 412 can include at least one feature formed thereon that is configured to facilitate rotation of the compression screw. In some embodiments, the at least one feature can include knurling, one or more protrusions or recesses, etc. In the illustrated embodiment, the at least one feature includes a series of splines 420 extending around a circumference of a proximal portion of the screw 412.

In certain embodiments, it may be difficult for a user to directly access the compression screw 412 for tightening, due to the small size of the compression screw 412 or its location relative to the coupling port and other nearby components. For example, in nanoscale liquid chromatography systems, where fluidic couplings are often employed using tubes 302 with outer diameters of 1/16 of an inch or less, the compression screw 412 can be just a fraction of an inch in diameter. Accordingly, in some embodiments a driver 422 can be included in the fitting assembly 304 to provide a user with a more convenient surface to grasp for tightening the assembly to create a high pressure fluid seal. The driver 422 can be configured to selectively mate with the proximal portion of the compression screw such that rotation of the driver is transferred to the compression screw. For example, the driver 422 can include a recess (not shown) at its distal end that can be configured to receive the proximal end of the compression screw 412 therewithin. The recess of the driver 422 can include one or more features that interface with the one or more features formed on the proximal end of the compression screw 412 to prevent relative rotation of the two components. For example, the recess of the driver 422 can include a series of splines (not shown) that interface with the splines 420 on the compression screw 412. The driver 422 can also include a slot 424 extending along an axial length thereof that extends from an outer surface of the driver to at least halfway through a width thereof. This can allow the driver 422 to be selectively positioned around the tube 302 extending proximally from the fitting 304 and, for example, slip fit over the proximal end of the compression screw 412 for tightening by a user.

As shown in FIG. 4, the fitting assembly can also include a length of shrink tubing 426 disposed around portion of the tube 302 extending from the fitting assembly 304 to reinforce and protect the tube 302 from excessive strain or impact damage when a user is manipulating the fitting assembly 304. The above-mentioned slot 424 can be at least as large as the diameter of the tube 302 with shrink tubing 426 in some embodiments.

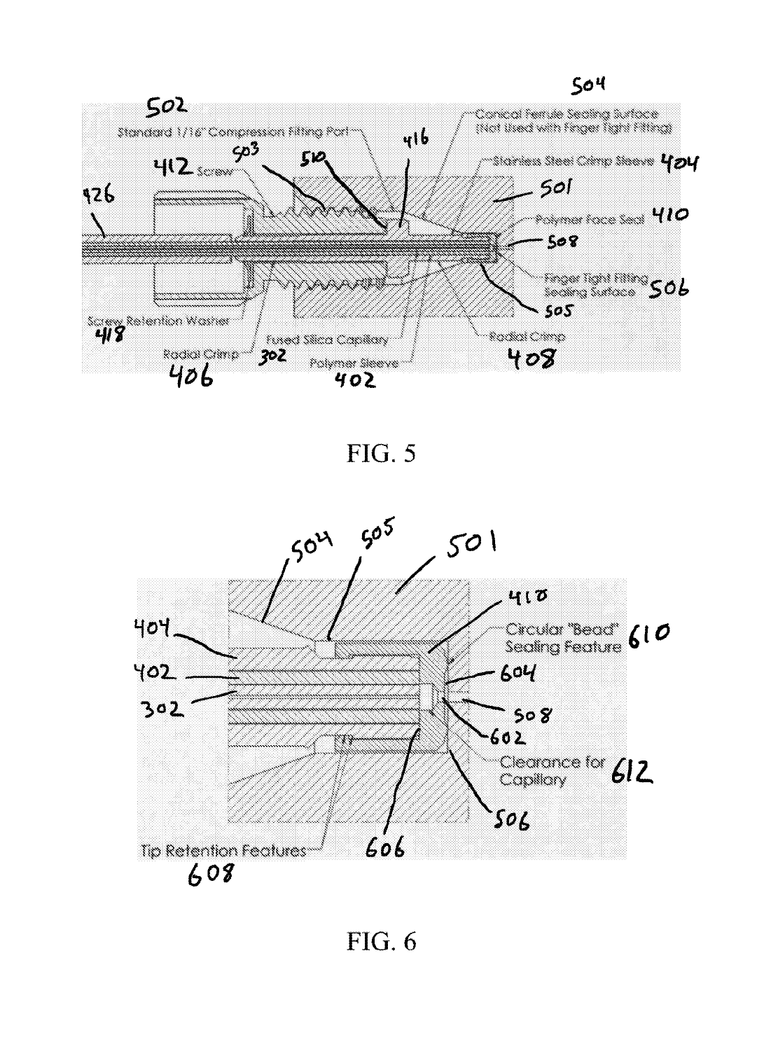

FIG. 5 illustrates a cross-section view of the fitting assembly 304 of FIG. 3 threaded into one embodiment of a coupling port 502, such as a 1/16-inch compression fitting port known in the liquid chromatography industry and commonly included in so-called nanoscale liquid chromatography systems. The coupling port 502 can be formed in a coupling body 501 and can include a first portion 503 having a first diameter, a second portion 505 having a second diameter, and a conical sealing surface 504 that can be configured to form a conventional fluid seal with a ferrule and compression screw. In some embodiments, the first diameter of the first portion can be greater than the second diameter of the second portion, and a fluid passage 508 can extend into the coupling body 501 from the bottom of the second portion. The conical sealing surface 504 can extend between the first and second portions to provide a transition between the first and second diameters. In some embodiments, the coupling port 502 can include threads formed along at least a portion of a length thereof, e.g., threads formed along at least a portion of the first portion 503. Though the port 502 can be configured for use with a conventional ferrule sealing element using the conical ferrule sealing surface 504, this surface need not be utilized to form a fluid tight connection when using the fitting assembly 304 according to the teachings of the present disclosure. Rather, the fitting assembly 304 can create a fluid-tight seal at a sealing surface 506 that is located at the bottom of the port 502.

More particularly, a user can form a high pressure fluidic coupling between a fluid passage 508 extending distally from the bottom of the port 502 and an inner lumen of the fused silica capillary tube 302 by grasping the compression screw 412 and threading it into the port 502. The compression screw 412 is disposed about the stainless steel sleeve 404, polymer sleeve 402, and fused silica tube 302 such that it can freely rotate relative thereto. Distal movement of the of the compression screw 412 relative to the sleeve 404 can be prevented by the drive feature 416 (e.g., a shoulder, protrusion, recess, or other feature) that abuts against a distal end drive surface 510 of the compression screw 412. Conversely, proximal movement of the compression screw 412 relative to the sleeve 404 can be prevented by the retainer 418 (e.g., a washer) that can be interference fit onto the metal sleeve 404 at a proximal end thereof.

As a user hand tightens the compression screw 412 into the port 502 using, e.g., the driver 422, the drive surface 510 of the compression screw 412 can urge the sleeve 404 distally by exerting an axial force on the drive feature 416 of the sleeve. This can urge the seal 410 of the fitting assembly 304 to contact the sealing surface 506 at the bottom of the port 502. Continued hand tightening of the compression screw 412 can urge the tube 302, polymer sleeve 402, and metal sleeve 404 distally and compress the seal 410 against the sealing surface 506 at the bottom of the port 502, thereby creating a fluid-tight seal. Because the sealing area at the end of the seal 410 is so small (e.g., when compared to the conical sealing area of a conventional ferrule-type fitting), less axial force is required to create a fluid tight seal. The lower axial force can be created with a reduced amount of torque on the compression screw 412, thereby enabling hand tightening of the fitting assembly 304. The elimination of the need for a wrench or other lever tool to tighten a compression screw can minimize the risk of overtightening and fracturing the tubing 302.

FIG. 6 illustrates a distal portion of the coupling shown in FIG. 5 in greater detail. As shown in the figure, the high strength inert polymer seal 410 can be disposed around a distal end of the tube assembly formed by the sleeve 404, polymer sleeve 402, and capillary tube 302. The seal 410 and distal end of the tube assembly can extend into the second portion 505 of the coupling port 502 such that the seal is compressed between a distal end of the tube assembly and the sealing surface 506 at the bottom of the port 502. The seal 410 can further include an axial bore 602 that extends between a distal sealing face 604 and a proximal sealing face 606 of the seal. The axial bore 602 can be positioned such that it aligns with the inner lumen of the tube 302 and, when installed in the port 502, also aligns with fluid passage 508. To aid in positioning the seal 410, and to ensure that the seal remains in contact with the metal sleeve 404, the seal and the sleeve can include one or more complementary features 608 to retain the position of the seal relative to the sleeve. For example, in the illustrated embodiment the sleeve 404 can include a groove formed in an outer surface thereof and the seal 410 can include one or more protrusions formed on an inner surface thereof that can snap into the groove to maintain the position of the seal. Advantageously, the seal 410 can be selectively separated from the sleeve 404 by elastically deforming the seal to release the protrusions or other features from the groove. This can be utilized to, for example, replace a damaged or worn seal with a new one.

The seal 410 can also include features to aid in creating a high pressure fluid seal at the sealing surface 506 of the port 502. For example, in some embodiments the seal 410 can include one or more protrusions on the distal sealing face 604, such as the annular ridge 610 shown in the illustrated embodiment. The annular ridge 610 can be positioned around the axial bore 602 and can provide a surface that, as the seal 410 is compressed against the sealing surface 506 of the port 502, experiences a concentrated spike in pressure. This annular portion of the seal can aid in forming a high pressure fluid seal around the axial bore 602 that can withstand operating pressures found in, e.g., nanoscale liquid chromatography systems.

Still further, the seal 410 can include features to prevent excess axial force from being applied to the fused silica or other tubing during tightening of the fitting. For example, in some embodiments the seal 410 can include a recess 612 formed in the proximal sealing face 606 that is coaxial with the axial bore 602 and can have a diameter substantially equal to a diameter of the tube 302. The recess 612 can provide relief because, as the seal 410 is compressed during tightening of the compression screw 412, the seal can expand axially into the sleeve 404 (thereby shrinking the size of the recess) rather than transferring increased axial force to the fused silica tube 302. This can prevent fracture of the fragile fused silica tube 302 as the compression screw 412 is tightened. The reduction in size of the recess 612 during tightening of the compression screw 412 can also be advantageous in that any possible unswept or dead volume is further reduced.

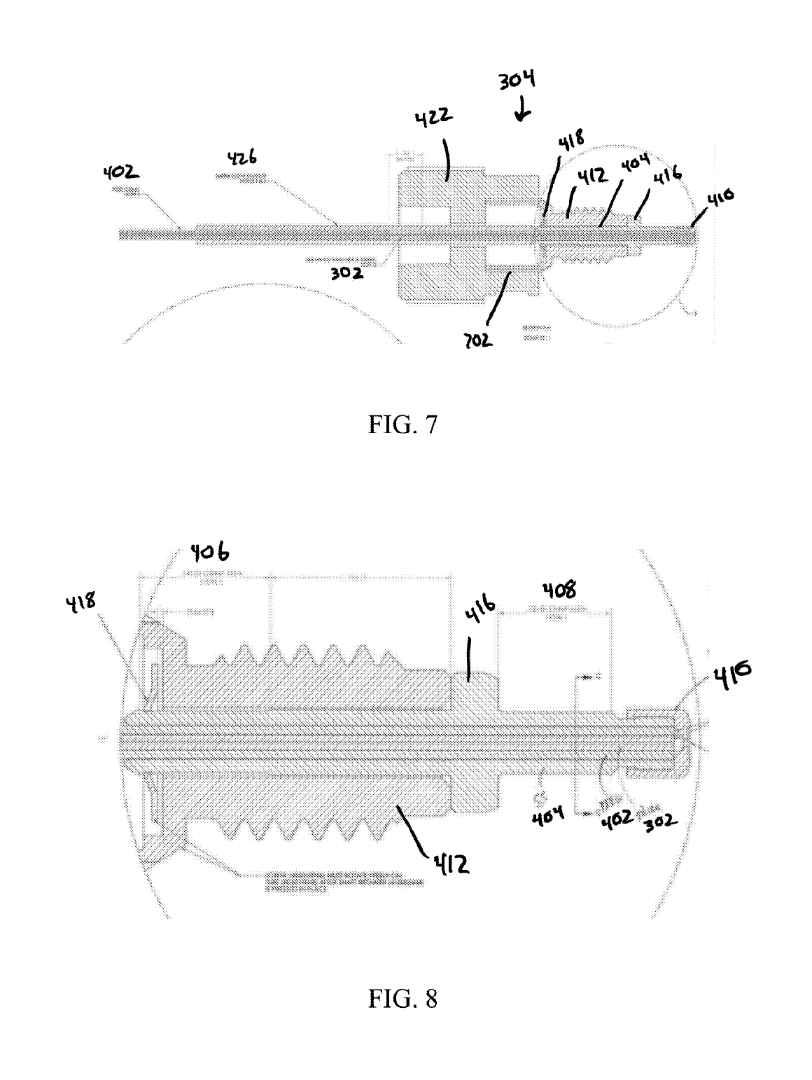

FIG. 7 illustrates a cross-sectional view of the fitting assembly 304 without the port 502 and including the driver 422. The driver 422 can include a recess 702 formed in a distal end thereof that is configured to receive a proximal end of the compression screw 412 therewithin. Further, one or more surfaces of the recess can include one or more features designed to interface with one or more features formed on a proximal outer surface of the compression screw 412 such that rotational force applied to the driver 422 is transferred to the compression screw. As explained in more detail below, such features can include, for example, one or more splines of various profiles, as well as various configurations of flat and/or curved surfaces, protrusions, and recesses.

FIG. 8 illustrates a detail view of the distal portion of the fitting assembly 304 shown in FIG. 7. The various components of the fitting assembly 304 are shown, along with the locations of the proximal crimp 406 and distal crimp 408. Both the proximal and distal crimps 406, 408 can have a variety of configurations. In some embodiments, the proximal and distal crimps 406, 408 can be radial crimps, such as a hexagonal crimp surrounding a circumference of the sleeve 404, that securely couples the sleeve 404 to the polymer sleeve 402 and the capillary tube 302. The polymer sleeve 402 can serve to reinforce the capillary tube 302 and protect it from fracture resulting from forces applied during the crimping process. The proximal and distal crimps 406, 408 can form fluid-tight seals in some embodiments that prevent liquid from passing between the capillary tube 302 and the polymer sleeve 402, and between the polymer sleeve 402 and the metal sleeve 404.

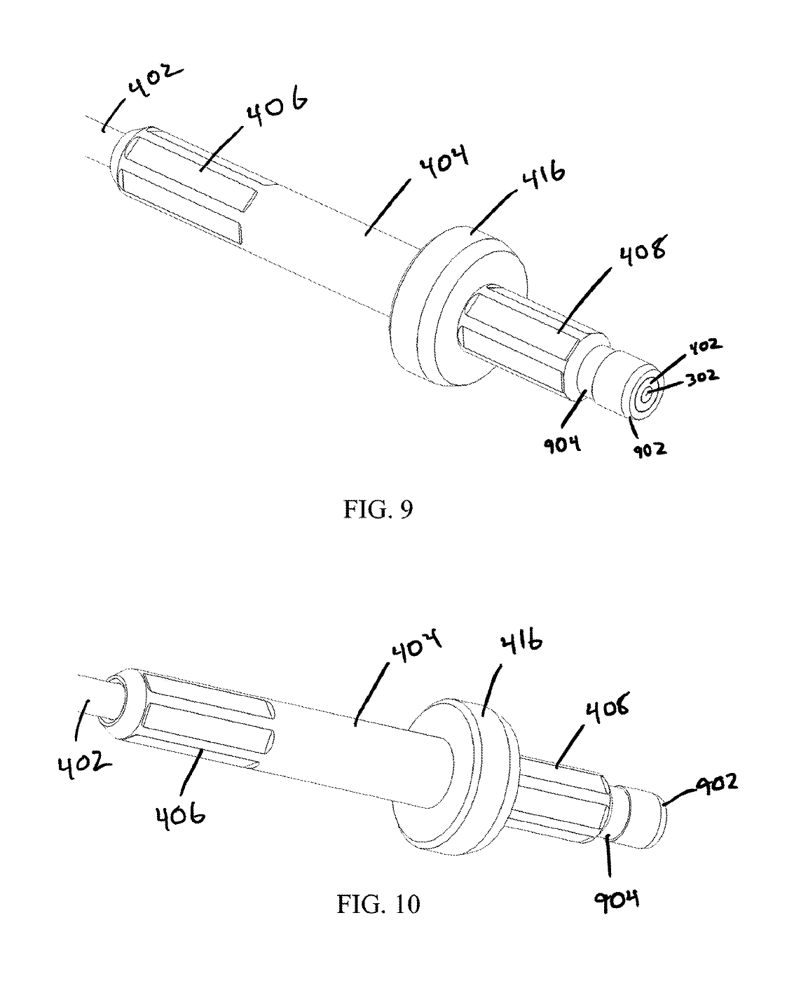

FIGS. 9 and 10 illustrate alternative perspective views of the sleeve 404 of the fitting assembly 304. As mentioned above, the sleeve 404 can be formed from a variety of materials but, in some embodiments, can be formed from a metal, such as a stainless steel alloy. The sleeve 404 can be joined to the polymer sleeve 402 and fused silica or other capillary tube 302 via a proximal crimp 406 and/or a distal crimp 408. The sleeve 404 can include a drive feature 416 formed thereon that can be configured to abut against or otherwise interface with a portion of a compression screw (e.g., a distal end thereof) to allow the compression screw to urge the sleeve (and the tube 302 coupled thereto) axially to create a fluid-tight seal in a coupling port. The drive feature 416 can have a variety of configurations and, in some embodiments, can be a partial- or full-circumference shoulder extending beyond an outer diameter of the sleeve 404. The drive feature 416 can be formed integrally with the sleeve 404 in some embodiments and can be a separate component selectively or permanently coupled to the sleeve 404 in other embodiments.

A distal end of the sleeve 404 can be configured to receive a seal thereover. For example, in some embodiments a distal end of the sleeve 404 can include a chamfered outer edge 902 to facilitate passing a seal, such as the seal 410, over the distal end of the sleeve 404. Still further, the sleeve 404 can include one or more features to help locate and retain the seal 410 in position. In the illustrated embodiment, the sleeve 404 includes a groove 904 formed around an outer circumference of the sleeve 404 a distance proximally from a distal end thereof. The groove can be positioned such that one or more protrusions or other features formed on an inner surface of the seal 410 can locate into the groove and provide interference to resist separation of the seal from the sleeve 404.

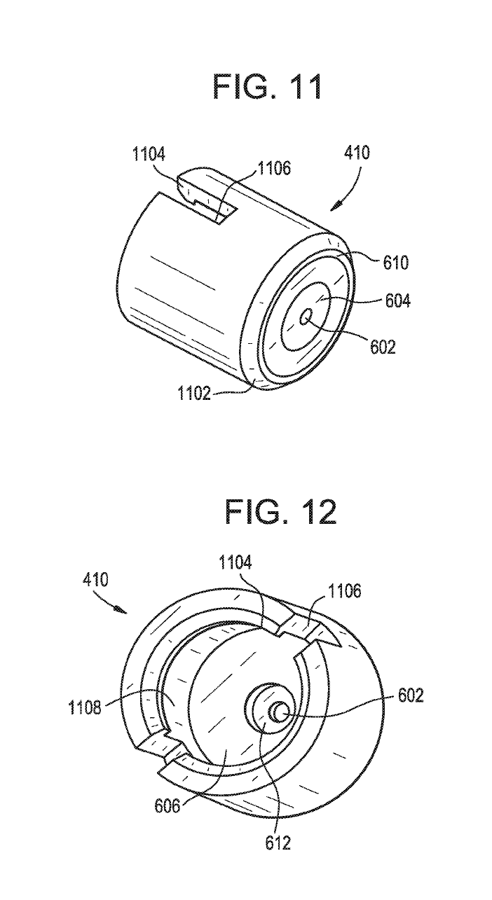

FIGS. 11 and 12 illustrate alternative perspective views of the seal 410 of the fitting assembly 304. The seal 410 is generally cylindrical in shape having a distal sealing face 604 and a proximal end with a recessed proximal sealing face 606. The front perspective view of FIG. 11 illustrates the distal sealing face 604, as well as the axial bore 602 formed through the seal and the annular ridge 610 formed around the axial bore 602. Also shown at a distal end of the seal 410 is a chamfered outer edge 1102 that can aid in passing the distal end of the fitting assembly 304 into a narrow diameter port to create a fluidic coupling. The chamfered edge 1102 can also leave expansion space at the distal end of the fitting assembly 304 that can be filled as the seal 410 is compressed between the bottom of a port and the distal end of the sleeve 404, polymer sleeve 402, and tube 302 during fluidic coupling.

A proximal end of the seal 410 can include one or more features, such as radially inwardly extending protrusions 1104 that can be configured to locate into the groove 904 or other retention feature formed in the sleeve 404 to selectively prevent the separation of the seal from the sleeve. The protrusions 1104 can be chamfered or otherwise angled along a proximal-facing surface thereof to facilitate sliding the seal 410 over a distal end of the sleeve 404. A distal-facing surface of the protrusions can be oriented so as to provide interference that resists separation of the seal 410 from the sleeve 404. For example, a planar distal-facing surface of the protrusion 1104 can abut against a planar proximal-facing surface of the groove 904. While the illustrated embodiment shows protrusions 1104 configured to locate within a grove 904, in other embodiments different features, such as any combination of protrusions, recesses, or planar or curved surfaces, can be utilized. For example, in some embodiments an annular recess could be formed in the seal to receive an annular protrusion formed on the sleeve.

As noted above, the seal 410 can be formed from a variety of materials. In some embodiments, the seal 410 can be formed from a high strength inert polymer material to aid in forming a high pressure fluid connection and avoid contaminating any sample fluids passed through the axial bore 602 of the seal. The polymer or other material can be elastically deformable to allow for passage over the distal end of the sleeve 404. As a result, the seal 410 can be selectively separated from the sleeve 404 in order to, for example, replace a damaged or worn seal. In some embodiments, the seal 410 can include one or more features to facilitate elastic deformation of the seal during installation of removal from the distal end of the sleeve 404. For example, in some embodiments the seal can include opposed slots 1106 formed in a proximal end thereof that can provide stress relief and permit easier deformation of the seal to, e.g., release the protrusions 1104 from the groove 904 formed in the sleeve 404. Each slot 1106 can, in some embodiments, start at a proximal end of the seal 410 and extend part-way toward a distal end thereof.

As shown in FIG. 12, a proximal sealing face 606 of the seal 410 can be recessed below a proximal sidewall 1108 of the seal such that the proximal sidewall 1108 of the seal is disposed around a distal end portion of the sleeve 404 when a distal end of the sleeve 404 abuts against the proximal sealing face 606. The one or more protrusions 1104 can be formed on an inner portion of the proximal sidewall 1108 at or near a proximal end of the seal 410. Also visible in FIG. 12 is the recess 612 that can protect against excess axial force fracturing the tube 302 during tightening, and the axial bore 602 that can align with an inner lumen of the tube 302.

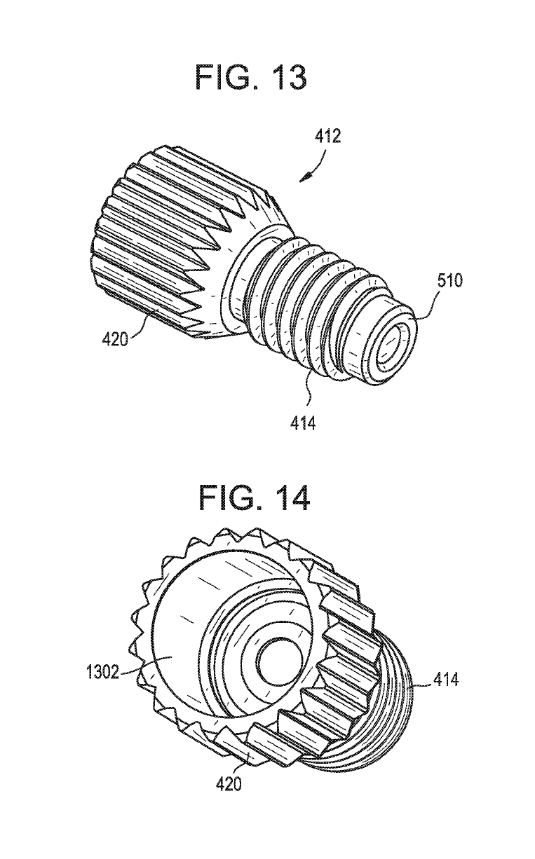

FIGS. 13 and 14 illustrate alternative perspective views of the compression screw 412 of the fitting assembly 304. As described above, the compression screw 412 can include a drive surface 510 at a distal end thereof that can be configured to abut against a drive feature 416 formed on the sleeve 404 so as to urge the sleeve 404 and tube 302 distally as the compression screw 412 is threaded into a coupling port. In order to facilitate threaded engagement with a coupling port, the compression screw 412 can include threads 414 disposed along at least a portion of a length thereof. Any of a variety of thread shapes, pitches, and diameters can be employed.

At a proximal end or along a proximal portion of the compression screw 412, one or more features can be included to facilitate rotating the compression screw 412 directly or via a tool, such as the driver 422. In the illustrated embodiment, an outer proximal surface of the compression screw 412 can include a series of splines 420 configured to be received within the driver 422, as described in more detail below. The series of splines 420 can have any of a variety of shapes and numbers, and other features are possible in place of splines 420, including any of a variety of planar or curved surfaces, protrusions, and/or recesses that can be configured to mate with complementary features formed on a surface of a recess in the distal end of the driver 422.

In some embodiments, the proximal end of the compression screw 412 can also include a recess 1302 formed therein. The recess can be sized to accept the retainer 418 (e.g., a washer) that can be coupled to a proximal end of the sleeve 404 via, for example, an interference fit. The retainer 418 can abut against the bottom surface of the recess 1302 of the compression screw 412 and can prevent the compression screw from separating from the sleeve 404 when, for example, the compression screw is backed out of a compression port. The interference between the retainer 418 and the bottom surface of the recess 1302 can serve to urge the sleeve 404 and tube 302 proximally in order to disconnect a fluidic coupling.

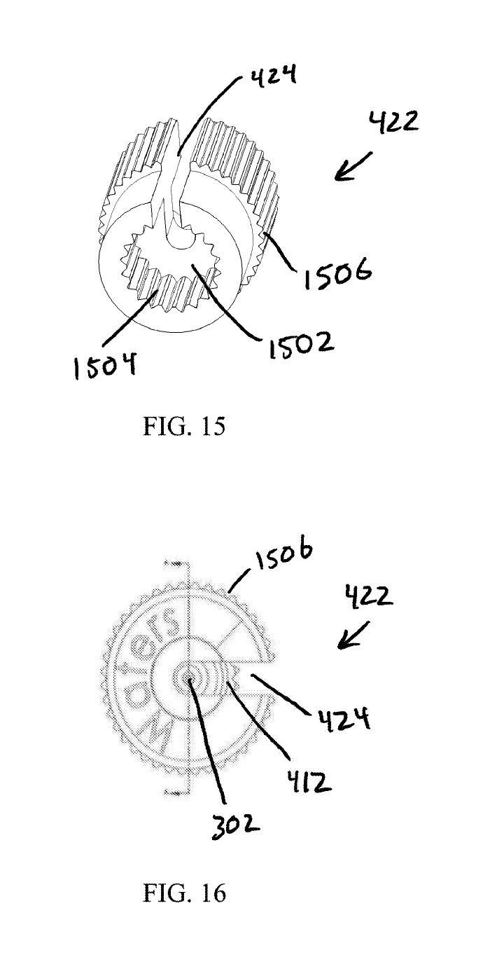

FIGS. 15 and 16 illustrate the driver 422 that can be configured to facilitate a user hand-tightening a fluidic coupling via the compression screw 412. The driver 422 can include a slot 424 formed therein to permit selective attached of the driver to the compression screw by receiving the capillary tube 302 through the slot 424. The slot 424 can extend from an outer surface of the driver to at least halfway through the driver in the radial direction. The slot 424 can also extend along an entire axial or longitudinal length of the driver 422 such that the capillary tube 302 can be passed through the slot 424 and the driver can be selectively positioned around the tube 302 without having to pass an end of the tube through a central bore in the driver.

Once the tube is positioned coaxially with the driver 422, the driver can be moved distally to slip fit over a proximal end of the compression screw 412 such that a recess 1502 formed in a distal end of the driver 422 surrounds a proximal portion of the compression screw 412. The recess 1502 can include one or more features formed on a wall that can complement one or more features formed on an exterior surface of the compression screw 412 such that rotation of the driver 422 can cause rotation of the compression screw 412. For example, in the illustrated embodiment a sidewall of the recess 1502 can include a series of splines 1504 that can be complementary to the splines 420 formed on the outer proximal surface of the compression screw. As the driver 422 is moved proximally over the proximal portion of the compression screw 412, the splines 420 and 1504 can interface to rotationally couple the driver and compression screw.

The driver 422 can also include one or more features formed on an outer surface thereof that can facilitate grasping by a user for finger tightening or releasing of a fluidic coupling. For example, in some embodiments the driver 422 can include a series of ridges 1506 formed around an outer circumference thereof that can aid a user in grasping and applying rotational force to the driver 422. In other embodiments, different features can be included, such as knurling or other patterning, as well as any combination of protrusions, recesses, curved, and/or planar surfaces.

FIG. 16 illustrates a top view of the driver 422 coupled to the compression screw 412. To achieve the configuration of FIG. 16, a user can position the driver 422 proximally (i.e., above or above the plane of the figure) of the compression screw 412 and pass the capillary tube 302 through the slot 424 formed in the driver until the capillary tube and driver are coaxially aligned. The driver 422 can then be advanced distally (i.e., down or towards the plane of the figure) until the recess 1502 formed in the distal end of the driver receives a proximal end of the compression screw 412 therewithin. Once the proximal end of the compression screw 412 is received within the recess 1502 and the splines 1504 mate with the splines 420 on the compression screw 412, the two components can be rotationally coupled. A user can then grasp the driver 422 using the ridges 1506 and rotate the compression screw 412 to tighten or release a fluidic coupling.

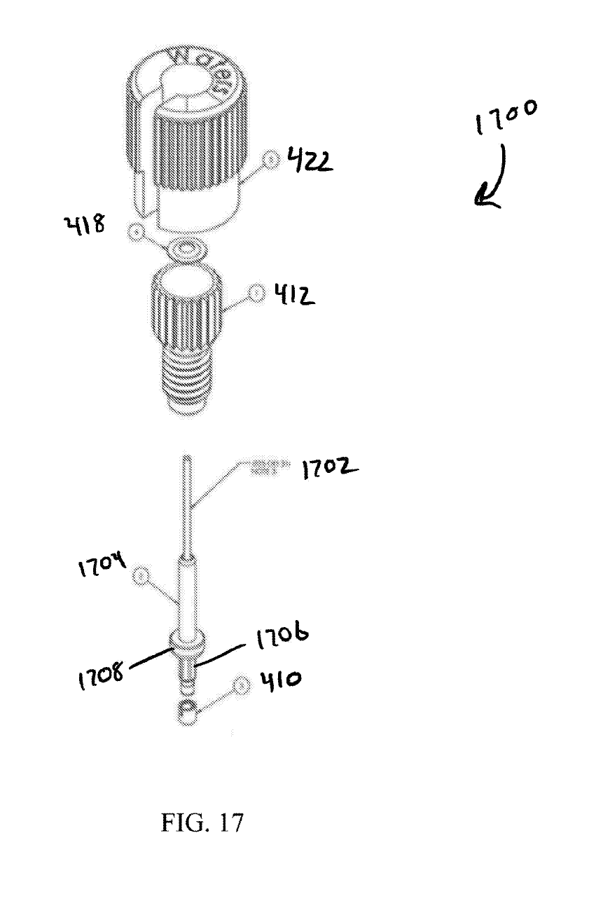

The above-described fitting assembly 304 makes use of a fused silica capillary tube 302, but in other embodiments different tube materials can be used. FIGS. 17-20 illustrate an alternative embodiment of a fitting assembly 1700 in which a tube 1702 is formed from a metal, such as stainless steel. Because the stainless steel tube 1702 can be less fragile than the fused silica tube 302, a metal (e.g., stainless steel) sleeve 1704 can be crimped or otherwise coupled directly thereto via, e.g., welding without the need for an intervening component, such as the polymer sleeve 402. In the illustrated embodiment, for example, the sleeve 1704 can be coupled to the tube 1702 via a plurality of crimps 1706 near a distal end thereof. In some embodiments, a distal end of the sleeve 1704 can be welded to the tube 1702 using, e.g., laser welding, to create a fluid tight seal between the sleeve and the tube following crimping.

The sleeve 1704 can include a drive feature 1708 similar to the drive feature 416 described above. The drive feature 1708 can be configured to abut against a distal end of the compression screw 412 to allow the screw to urge the sleeve 1704 and tube 1702 distally as it is threaded into a coupling port. The compression screw 412 can rotate freely relative to the sleeve 1704 and the above-described retainer 418 can be similarly interference fit onto a proximal end of the sleeve to prevent the compression screw from proximally separating from the sleeve.

Similar to the embodiment of the fitting assembly 304 described above, the fitting assembly 1700 can include a driver 422 that can be configured to interface with the compression screw 412 and allow a user to finger tighten the fitting. Finger tightening can be made possible by using the seal 410 disposed over a distal end of the sleeve 1704 that forms a fluid tight seal at the bottom of a coupling port and does not require the permanent deformation of a sealing element, such as a ferrule.

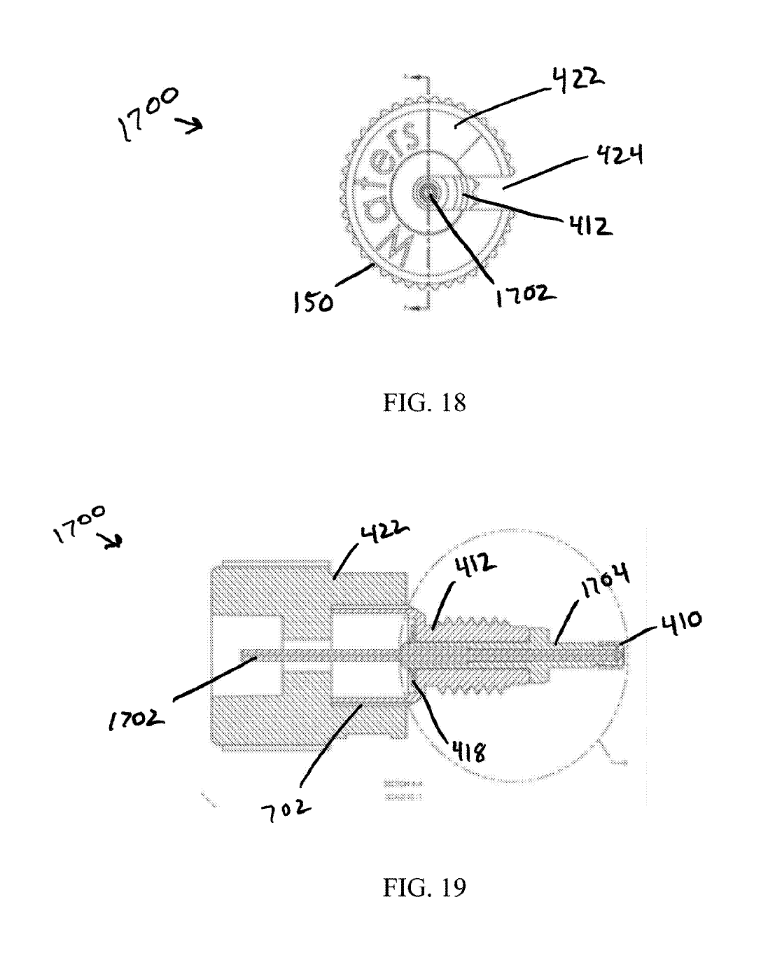

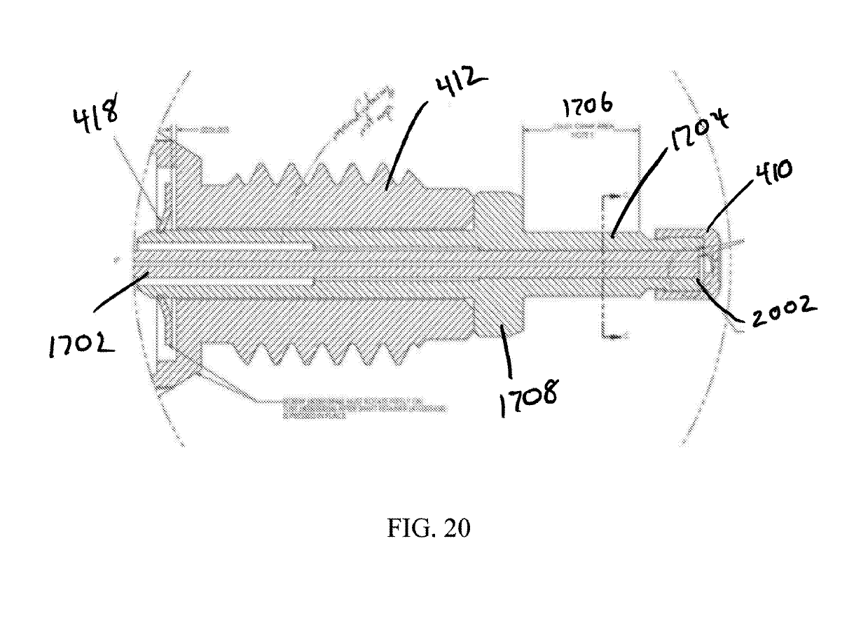

FIG. 18 illustrates a top view of the assembly 1700 with the driver 422 fitted over a proximal end of the compression screw 412 and the stainless steel tube 1702 extending out of the plane of the figure. FIG. 19 illustrates a side cross-sectional view of the assembly 1700 along the line A-A of FIG. 18. In this view, the proximal end of the compression screw 412 can be seen received within the recess 702 of the driver 422 to rotationally couple the two components. FIG. 20 illustrates the tube 1702, sleeve 1704, seal 410, compression screw 412, and retainer 418 in greater detail. The assembly can be similar to the embodiment described above utilizing fused silica tube 302, but can omit the polymer reinforcement sleeve 402. Moreover, because the stainless steel tube 1702 is less fragile, a single distal portion crimp area 1706 can be utilized to couple the sleeve 1704 and the tube 1702. In some embodiments, a laser or other weld 2002 can be formed between the sleeve 1704 and the tube 1702 at a distal end thereof to ensure a fluid tight seal between the components.

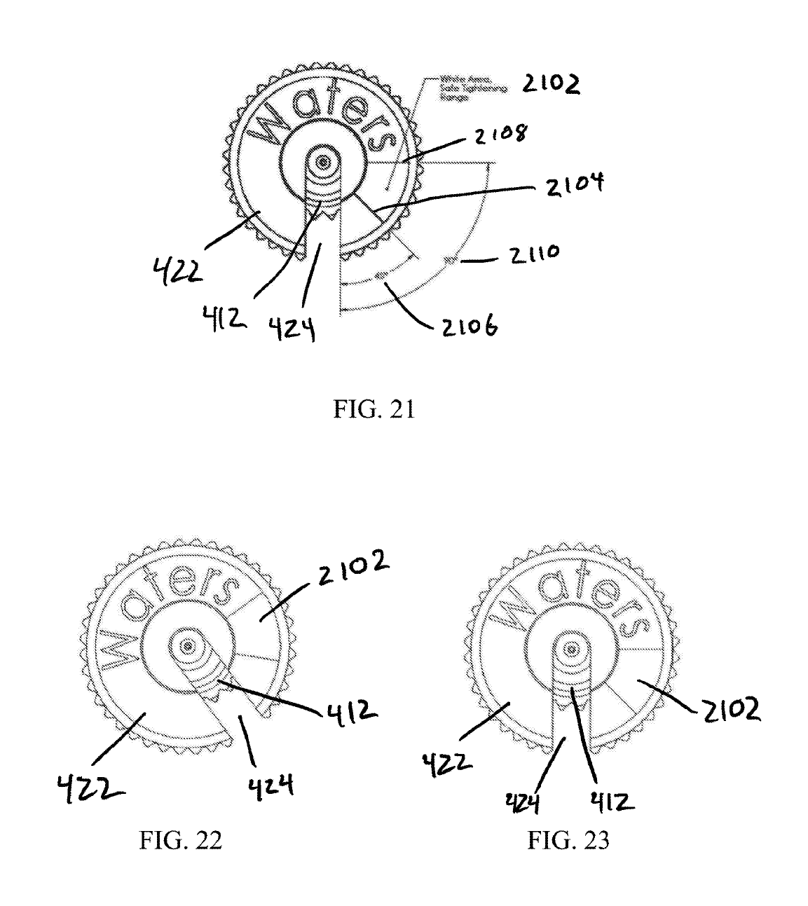

Regardless of the particular embodiment of the capillary tube and sleeve, the same type of compression screw 412 and driver 422 can be employed, though there may be variations in size associated with different diameter tubes, etc. As noted throughout, one advantage of the fitting assemblies described herein is the ability for a user to hand-tighten the assembly to create a high pressure fluidic coupling. In some embodiments, a tightening aid can be included with the fitting assemblies described herein to provide a user with feedback regarding proper tightening displacement. As shown in FIG. 21, the driver 422 can include a visual tightening aid 2102 in some embodiments to aid a user in creating a seal between the tube 302 or 1702 and a fluid passage of a coupling port. The visual tightening aid 2102 can have a variety of configurations but, in some embodiments, can be a wedge-shaped region formed on a proximal surface of the driver 422. The wedge-shaped region can be formed by stamping, printing, painting, engraving, or any of a variety of other marking technologies known in the art. For example, in some embodiments the driver 422 can be formed from a polymer material and the wedge-shaped region can be molded into the proximal surface thereof. Of course, the visual tightening aid 2102 can be included on a different surface of the driver 422, such as around an outer circumference of a sidewall thereof.

The wedge-shaped visual tightening aid 2102 can be configured such that a leading edge 2104 of the region forms a first angle 2106 with an index or reference feature of the driver 422, such as the slot 424 formed therein. In other embodiments, the index or reference feature can be any of a slot, line, notch, etc. The first angle 2106 indicated by the visual tightening aid can correspond to a minimum tightening angular displacement necessary to create a high pressure fluid seal once the fitting assembly 304 or 1700 has been threaded into a coupling port, such as port 502, far enough that the seal 410 contacts a bottom sealing surface 506 of the port. Similarly, a trailing edge 2108 of the visual tightening aid can form a second angle 2110 with the index, such as an edge of the slot 424. The second angle 2110 can correspond to a maximum safe tightening displacement that can prevent damage to the seal 410 or tube 302.

FIGS. 22-25 illustrate one embodiment of a method of utilizing the visual tightening aid 2102 to safely hand tighten a fitting assembly into a coupling port to form a high pressure fluidic coupling. Such a fluid tight coupling can be capable of withstanding pressures above about 1,000 psi in some embodiments, or above about 10,000 psi in other embodiments. Such a method can include threading a compression screw (e.g., compression screw 412) of a fitting (e.g., fitting 304) into a port (e.g., port 502) until a seal (e.g., seal 410) surrounding a distal end portion of the fitting contacts a bottom surface (e.g., surface 506) of the port. Threading can be completed by a user via direct manipulation of the compression screw 412 or, if the compression screw is too small and/or difficult to grasp, using a driver. Accordingly, the method can also include coupling a driver (e.g., driver 422) to the compression screw by sliding the driver distally onto a proximal end of the compression screw such that the proximal end of the compression screw is received within a recess formed in a distal end of the driver and complementary mating features formed on the driver and the compression screw interface to prevent relative rotation between the driver and the compression screw.

If a driver is utilized to initially thread the compression screw into the coupling port, the driver can be randomly positioned when the seal at the distal end of the fitting assembly initially contacts the bottom of the port. Accordingly, the method can include orienting the driver relative to the compression screw such that a position of a reference feature on the driver relative to the compression screw is known. For example, as shown in FIGS. 22 and 23, the driver 422 can be proximally separated from the compression screw 412, rotated such that a reference feature, such as the slot 424, is oriented in a known manner (e.g., at a 6-o'clock clock position in the case of FIG. 23), and moved distally to again rotationally couple to the compression screw 412. Of course, if a user directly manipulates the compression screw 412 by hand to initially thread the compression screw into the port, the driver 422 can be initially coupled to the compression screw in the orientation shown in FIG. 23 without repositioning from another orientation, e.g., the orientation shown in FIG. 22. Still further, in some embodiments the position of the driver 422 need not be reoriented as shown in FIGS. 22 and 23, as a user can simply note the position of the reference feature (e.g., slot 424) and proceed as described below.

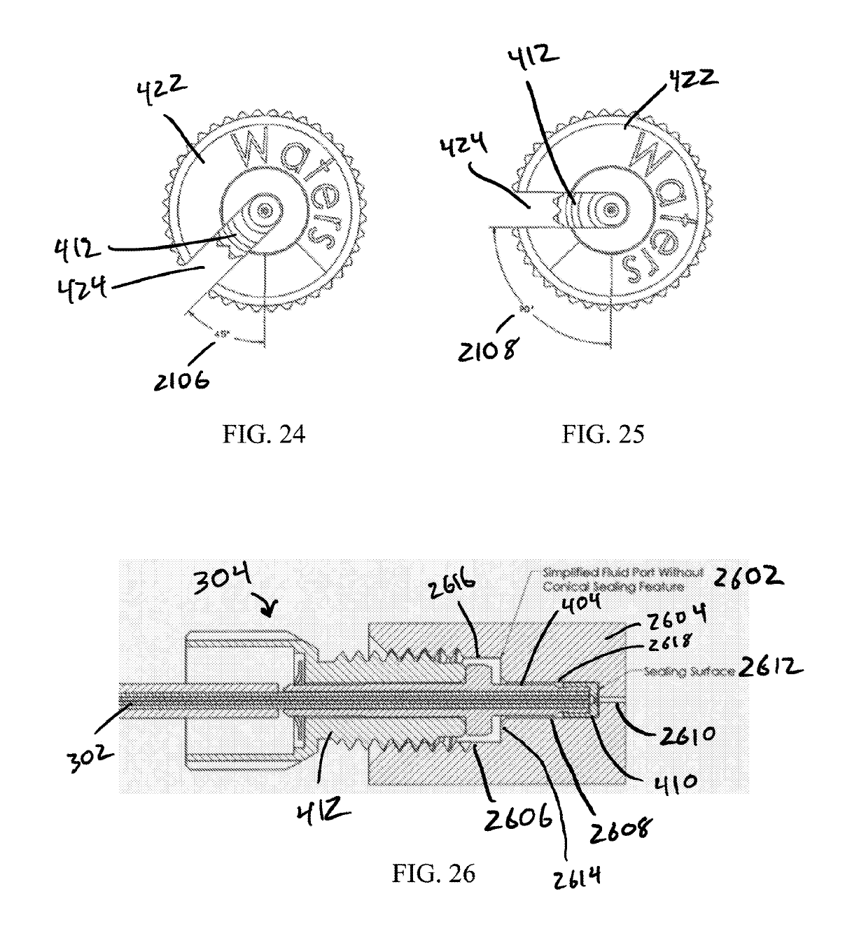

In order to complete the formation of a high pressure fluid seal, the user can then hand-tighten the fitting using the driver 422 by rotating the driver from the first position shown in FIG. 23 (or, as noted above, from any first position in which the orientation of a reference feature, such as the slot 424, is known) to a second position, wherein an angle between the first position and the second position corresponds to an angle indicated by the visual tightening aid 2102 formed on the driver. FIG. 24 illustrates one embodiment of the second position wherein the driver 422 has been tightened a minimum amount necessary to form a high pressure fluidic coupling, while FIG. 25 illustrates another embodiment of the second position wherein the driver has been tightened a maximum amount to form a high pressure fluidic coupling without damaging components of the fitting assembly, such as the seal or capillary tube. In other embodiments, the second position can be anywhere between the minimum position illustrated in FIG. 24 and the maximum position illustrated in FIG. 25.

While the wedge-shaped region is provided as an example of a visual tightening aid 2102, other embodiments can include differently shaped regions that similarly convey an upper and lower limit to tightening displacement to aid a user in finger tightening a fluidic coupling fitting. Moreover, in some embodiments the visual tightening aid can be formed on a different component, such as on the housing of the coupling body surrounding the coupling port. In one embodiment, for example, a wedge-shaped region similar to the aid 2102 can be formed on a coupling port to illustrate minimum and maximum tightening angular displacement relative to, for example, an index marking also formed on the housing. In use, a user could align a marking on the driver 422 with the index mark and then tighten until the index mark is positioned between the minimum and maximum tightening lines of the wedge-shaped region.

Moreover, the illustrated embodiments make use of exemplary angle ranges that correspond to minimum and maximum tightening displacements. For example, the minimum angle shown in FIGS. 21 and 24 is about 45 degrees, while the maximum angle shown in FIGS. 21 and 25 is about 90 degrees. These are exemplary angles and can vary across embodiments depending upon the amount of tightening necessary to create the desired fluidic coupling.

As noted above, one advantage of the fittings described herein is the elimination of a conical sealing ferrule when creating a high pressure fluid seal. The elimination of a ferrule can reduce the complexity associated with forming a coupling port for use with a male fitting assembly. This is because forming a conical sealing surface can require complex manufacturing processes, especially where the conical sealing surface must be smooth to enable formation of a good seal. When utilizing the fitting assemblies described herein, however, simple cylindrical bores can be utilized in forming a coupling port. FIG. 26 illustrates one embodiment of a coupling port 2602 having a simplified cylindrical bore structure that can be utilized with, e.g., the fitting assembly 304 described herein. The coupling port 2602 can be formed in a housing 2604 and can include a first bore 2606, a second bore 2608, and a fluid passage 2610. The first bore 2606 can include threads formed along at least a portion thereof that can interface with threads formed on the compression screw 412, for example. The second bore 2608 can be smaller in diameter than the first bore 2606 and can be configured to receive a distal portion of the fitting assembly 304, including a distal end thereof having the seal 410 disposed thereabout. A high pressure fluidic coupling can be formed between the tube 302 and the fluid passage 2610 as the compression screw 412 is tightened and the seal 410 is compressed between a distal end of the sleeve 404 and the bottom sealing surface 2612 of the port 2602.

Of note is that an angle between a bottom surface 2614 of the first bore 2606 and a sidewall 2616 of the first bore is about 90 degrees. Similarly, an angle between the bottom surface 2612 of the second bore 2608 and a sidewall 2618 of the second bore is about 90 degrees. Forming approximately cylindrical bores in this manner can be performed with fewer operations during manufacturing, thereby reducing time and cost. Such efficiency increases can be accomplished without sacrificing quality of fluidic coupling due to the design of the seal 410 disposed around a distal end of the fitting assemblies described herein.

One skilled in the art will appreciate further features and advantages of the disclosure based on the above-described embodiments. Accordingly, the disclosure is not to be limited by what has been particularly shown and described, except as indicated by the appended claims. All publications and references cited herein are expressly incorporated herein by reference in their entirety.

1. A fitting for coupling fluidic paths, comprising:
a compression screw having threads formed along at least a portion of an outer surface thereof and a drive surface formed at a distal end thereof;
a tube extending through an axial bore of the compression screw that is configured to carry fluid;
a sleeve disposed around the tube and including a drive feature formed on an outer surface thereof that is configured to abut against the drive surface of the compression screw; and
a seal coupled to the sleeve such that the seal surrounds a distal end portion of the sleeve;
wherein the seal includes an axial bore formed between a distal sealing face and a proximal sealing face of the seal that is aligned with a fluid path of the tube.

2. The fitting of claim 1, wherein a distal end of the tube and a distal end of the sleeve are positioned proximal to the proximal sealing face of the seal.

3. The fitting of claim 1, wherein the seal further includes a recess formed in the proximal sealing face thereof that is coaxial with the axial bore formed through the seal.

4. The fitting of claim 3, wherein the recess has a diameter substantially equal to a diameter of the tube.

5. The fitting of claim 1, wherein the seal further includes an annular ridge formed on the distal sealing face that surrounds the axial bore.

6. The fitting of claim 1, wherein the seal has a generally cylindrical shape with the proximal sealing face being recessed below a proximal end of a sidewall of the seal such that the sidewall of the seal is disposed around the distal end portion of the sleeve when a distal end of the sleeve abuts against the proximal sealing surface of the seal.

7. The fitting of claim 6, wherein the sidewall of the seal includes one or more features formed on an inner surface thereof that are configured to interface with one or more complementary features formed on an outer surface of the sleeve to prevent the seal from separating from the sleeve.

8. The fitting of claim 7, wherein the one or more features formed on the inner surface of the sidewall of the sleeve includes a radially inward extending protrusion and the one or more complementary features formed on the outer surface of the sleeve includes a groove.

9. The fitting of claim 6, wherein the sidewall of the seal includes at least one slot formed therein that extends along a portion of a length of the seal.

10. The fitting of claim 6, wherein the seal is configured for selective separation from the distal end portion of the sleeve and wherein an outer distal edge of the sleeve is chamfered to facilitate insertion of the distal end portion of the sleeve into a recess of the seal.

11. The fitting of claim 1, wherein the seal is formed from a polymer.

12. (canceled)

13. (canceled)

14. The fitting of claim 1, further comprising a second sleeve that is disposed between the tube and the sleeve.

15. The fitting of claim 14, wherein the second sleeve is formed from polyether ether ketone (PEEK).

16. The fitting of claim 1, further comprising a housing having a coupling port formed therein that includes a first bore having threads formed along at least a portion of a length thereof, a second bore of smaller diameter than the first bore, and a fluid passage of smaller diameter than the second bore;
wherein the compression screw is configured to threadably mate with the first bore and the sleeve and the seal are configured to extend into the second bore such that the tube and the axial bore formed in the seal align with the fluid passage.

17. The fitting of claim 16, wherein an angle between a bottom surface of the first bore and a sidewall of the first bore is about 90° and an angle between a bottom surface of the second bore and a sidewall of the second bore is about 90°.

18. The fitting of claim 1, wherein the compression screw includes a proximal portion having at least one feature formed thereon that is configured to facilitate rotation of the compression screw.

19. The fitting of claim 18, further comprising a driver configured to selectively mate with the proximal portion of the compression screw such that rotation of the driver is transferred to the compression screw;
wherein the driver includes a recess formed therein that is configured to receive the proximal portion of the compression screw.

20. The fitting of claim 19, wherein an outer surface of the driver is configured to be grasped directly by a user to rotate the compression screw.

21. The fitting of claim 20, wherein the driver includes a visual tightening aid for creating a seal between the tube and the fluid passage of the housing.

22. The fitting of claim 21, wherein the visual tightening aid includes a wedge-shaped region formed on a proximal surface of the driver, wherein a leading edge of the region corresponds to a minimum tightening displacement and a trailing edge of the region corresponds to a maximum tightening displacement.

23-54. (canceled)
